(19) United States
(12) Patent Application Publication
(10) Pub. No.: US 2009/0212470 A1
(43) Pub. Date: Aug. 27, 2009

(54) Melting or Holding Furnace

(75) Inventor: Klaus Malpohl, Solingen (DE)

Correspondence Address: FAY KAPLUN & MARCIN, LLP, 150 BROADWAY, SUITE 702, NEW YORK, NY, 10038, US

(73) Assignee: StrikoWestofen GmbH, Wiehl-Bomig (DE)

(21) Appl. No.: 11/915,076

(22) PCT Filed: May 22, 2006
(86) PCT No.: PCT/EP06/05049

§ 371 Date: May 23, 2008

(30) Foreign Application Priority Data
May 23, 2005 (DE) 10 2005 024 924.8

(51) Int. Cl. F27B 3/06; F27B 3/19

(52) U.S. Cl. 266/240

(57) ABSTRACT

A melting or holding furnace includes a furnace chamber surrounded by a housing. The chamber holds the melt with a maximum filling level. The furnace also has an outlet opening for transferring the melt to another container. The outlet opening is provided with a shut-off valve for dosing the emerging melt. The valve is covered by melt in normal operation. The housing is connected to a tilting device which tilts the housing in such a manner that the shut-off valve can be freed from melt for the purpose of repairing it even at a maximum filling level.

The invention relates to a melting furnace or a holding furnace according to the preamble of the main claim.

Melting furnaces or holding furnaces which receive a molten mass, e.g. of aluminium, are known. This molten mass is usually transferred into another furnace, for example into a furnace for treating molten mass, when this transfer is realised by way of tilting the holding furnace in a controlled manner, by which means molten mass gets into the other furnace or container in a continuous manner or in small batches. Here, the accuracy of the metering of the molten mass is limited. Furthermore, it is a great disadvantage that the molten mass, e.g. the aluminium molten mass, is in contact with the surrounding air during the transfer, and oxidizes at the free surface.

Transfer ladles are known in the field of iron, which comprise bottom valves, wherein a transfer of the molten mass from the ladle into another container is carried out by way of opening the bottom valve, i.e. the plug. The ability to regulate the molten mass flow by way of valves is known. If such a bottom valve is to be overhauled due to the fact that the danger exists of a leakage of the valve, the ladle must be completely emptied for the repair of the valve. For this reason, this method is not applied for the transfer of molten masses from furnaces with a large capacity. Furnaces, in particular for receiving steel molten mass, which are tilted for transferring the molten mass, are known (EP 0 128 965 A1). Thereby, one does not apply tapping valves which are covered by molten mass in normal operation, since with these large furnaces there is the danger of leakages occurring between the valve element and the valve plug, and of the entire furnace, running out. Slide gates attached from the outside are applied, and the tapping opening is filled with a filler mass, e.g. gravel, for the protection of the slide gate.

It is the object of the invention to provide a melting furnace or holding furnace, with which it is possible to convey the molten mass in a metered manner into another container, without it coming into contact with the surrounding air, and with which an interruption of the operation due to repair and maintenance when using a valve for the transfer, is not necessary.

According to the invention, this object is achieved by the characterising features of the main claim in combination with the features of the preamble.

By way of the fact that the outlet opening of the melting and holding furnace is provided with a closure valve for metering a molten mass to be let out, which is covered with molten mass in normal operation, and that the housing of the furnace chamber is connected to a tilting device which tilts the housing in a manner such that the closure valve may be freed of the molten mass even with a maximum filling level, it is possible one the one hand to carry out a oxide-free transfer, i.e. amid the exclusion of air or oxygen, from the melting furnace or holding furnace, into another container on account of the valve with a high metering accuracy, also in a quasi-continuous manner, and on the other hand to carry out a repair of the closure valve, without the holding operation of the furnace having to be interrupted, or the furnace having to be completely or partly emptied.

Advantageous further formations and improvements are possible by way of the measures specified in the dependent claims.

It is particularly advantageous for the closure valve to be able to be controlled by way of an electrical drive, in a manner such that the desired quantity may be transferred in a metered manner, i.e. in a quasi-continuous manner. The transfer quantity of the molten mass is selected such that the level in the receiver furnace remains almost constant.

It is furthermore advantageous for the closure valve provided with a valve stem and valve body to comprise a gas passage, since with this, one may optimise an oxide-free transfer of the molten mass, wherein the surface of the molten mass in the receiving chamber of the tapping valve or closure valve may be covered with inert gas, as well as likewise the surface of the molten mass in the chamber of the receiver container.

This is realised with little effort by way of the fact that the inert gas is led through an axial bore in the valve stem and in the valve body.

Preferably, an outlet piece connects to the valve, and is designed such that it immerses into the molten mass of the receiver furnace, which therefore ends below the minimal level. Thereby, the gas supply also serves for conveying the molten mass out of the outlet piece by way of the pressure compensation, so that it does not freeze, after the closure of the valve.

One embodiment of the invention is represented in the drawing and is explained in more detail in the subsequent description. There are shown:

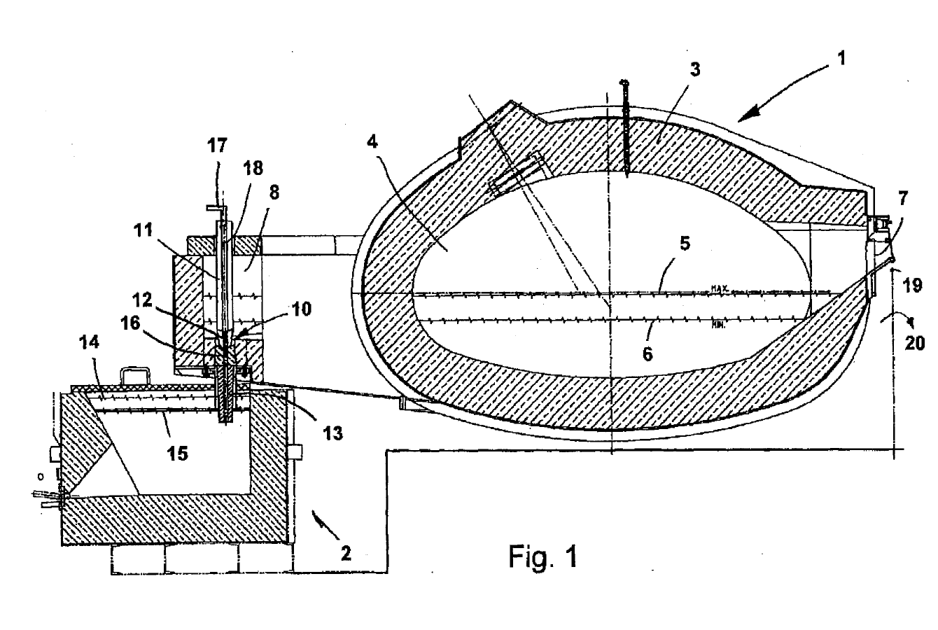

FIG. 1 a section through an arrangement of the inventive melting furnace and holding furnace, with a closure valve and a receiver furnace, and

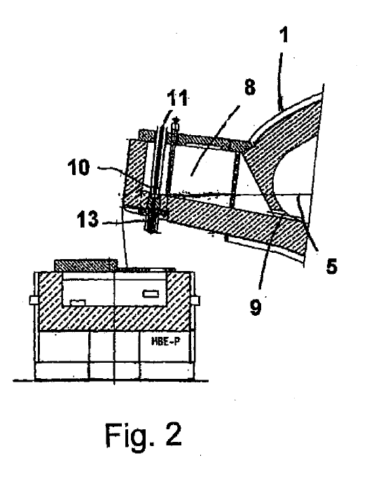

FIG. 2 a part section through the inventive melting and holding furnace, in the tilted condition with respect to the receiver furnace.

The melting furnace or holding furnace 1, and a receiver furnace 2 into which the molten mass is transferred from the holding furnace 1, are represented in FIG. 1 in the usual operational position of the furnace 1. The melting furnace or holding furnace 1 has a furnace space 4 which surrounds a flame-proof housing 3, and in which the melting bath is received between a maximal level 5 and a minimal level 6. Combustors which are not shown in more detail and which provide the necessary temperature, are provided in the housing 3. In the shown embodiment example, the melting furnace 1 is formed with a side pocket 8 forming a receiving chamber, which is connected to the remaining furnace space via a siphon (see FIG. 2).

A closure valve 10 for metering the molten mass to be let out and which is designed as a bottom tapping valve and which comprises a valve body 12 which may be actuated by a valve stem 11, is located in the side pocket 8. A valve element 16 which forms the valve seat, and an outlet element 13, connect to the valve body. The valve stem 11 is controllable via an electric drive which has not been shown, according to different opening positions of the valve body 12.

As may be recognised from FIG. 1, the outlet piece of the valve 10 projects through an opening in a cover of the receiver furnace 2, into this, wherein the molten mass bath received in the receiver furnace 2 likewise fluctuates between a maximal level 14 and a minimal level 15, and the outlet piece 13 projects so far into the receiver furnace 2, that it ends below the minimal level 15. Thus, the transfer of molten mass from the furnace 1 into the receiver furnace 2 is effected amid the exclusion of air and oxygen.

The valve 10 comprises a gas feed 17 for inert gas, by way of which an oxide-free transfer of the molten mass is to be optimised. For this, the valve stem and the valve body are provided with an axial bore 18 which is not shown in more detail in FIG. 1. Given an open valve, the inert gas supplied via the axial bore gets into the receiving chamber of the closure valve 10 formed in the side pocket 8, and produces an inert gas atmosphere there. With a closed valve, the inert gas is led through the outlet element 13 of the valve 10 into the melting chamber of the receiver furnace 2 and there produces an inert gas atmosphere.

A pour-out opening 7, via which the holding furnace 1 may be residually emptied, is located at the side of the housing 3 which lies opposite the closure valve 10. The housing 3 is provided with a tilting device, which is not represented, and which tilts the whole housing 3 with the melt bath and the side pocket 8 and valve 10 arranged therein, in a manner such that the outlet piece 13 of the valve is pivoted out of the receiver furnace 2 according to FIG. 2. Thereby, the pivoting angle or the tilting angle, depending on the distance between the valve in the side pocket (also called bay) and the tilt axis, is dimensioned such that the valve 10 is freed even at the maximal filling level 5. This may be recognised in FIG. 2. The tilt axis and the tilt direction are indicated at 19 and 20 in FIG. 1.

The outlet piece 13 of the valve 10 is removed for repair, and the freed closure valve may be examined e.g. by way of a visual inspection, with regard to metal attachments, in particular on the valve seat 16. Then, the valve body 12 or plug of the valve stem 11 or also the valve element 16 is exchanged for the repair or the overhaul of the valve. A cleaning of the bore in the valve body or in the valve element is likewise possible.

After the repair or the exchange of the valve 10, the furnace 1 is pivoted back again, so that the holding operation of the furnace does not need to be interrupted.

The tilting device of the furnace 1 may also be used for its complete emptying or for its residual emptying, via the opening 7, should this be required. For this, as with the freeing of the valve 10, the holding furnace 1 is tilted about the tilt axis 19 in the tilting direction 20, i.e. in the same direction as with the freeing.

1-10. (canceled)

11. A furnace which is one of a melting furnace and a holding furnace, comprising:
a furnace chamber surrounded by a housing, a molten mass being received in the furnace chamber with a maximum filling level; and
an outlet opening transferring the molten mass into a further container, the outlet opening including a closure valve which meters the molten mass to be let out, the valve being covered by the molten mass in a normal operation and being connected to an outlet piece, the outlet piece immersing into the further container when transferring the molten mass,
wherein the housing is connected to a tilting device, the tilting device tilting the housing in a manner such that the valve is capable of freeding of the molten mass for a repair purposes even when the furnace chamber is at the maximal filling level.

12. A furnace according to claim 11, wherein the valve is controllable using an electrical drive.

13. A furnace according to claim 11, wherein the valve includes a valve rod and a valve body designed as a blocking and regulation plug.

14. A furnace according to claim 11, wherein the furnace chamber is connected to a side pocket, the valve being situated in the side pocket.

15. A furnace according to claim 14, wherein the furnace chamber is connected to the side pocket via a siphon.

16. A furnace according to claim 11, wherein the valve is formed as a bottom valve.

17. A furnace according to claim 13, wherein the valve stem and the valve body of the closure valve has a gas passage, the gas passage selectively supplying gas into one of (a) at least one of the furnace chamber and the side pocket, and (b), via the outlet piece, the further container.

18. A furnace according to claim 17, wherein the valve stem and the valve body include an axial bore for the passage of gas.

19. A furnace according to claim 11, further comprising:
an emptying opening located in a side of the housing, the side being located opposite the valve, the emptying opening residually emptying the molten mass in a tilted condition using the tilting device.
